(19) United States
(12) Patent Application Publication
(10) Pub. No.: US 2002/0189256 A1
(43) Pub. Date: Dec. 19, 2002

(54) Engine intake air dryer

(75) Inventor: Yury Kalish, Birmingham, MI (US)

Correspondence Address: Robert C. Jones, Brooks & Kushman P.C., 22nd Floor, 1000 Town Center, Southfield, MI, 48075-1351, US

(73) Assignee: Detroit Diesel Corporation, Detroit, MI

(21) Appl. No.: 09/882,888

(22) Filed: Jun. 15, 2001

(51) Int. Cl. F02B 33/44

(52) U.S. Cl. 60/605.2

(57) ABSTRACT

A charge-air modification system for use with an internal combustion engine such as a diesel engine to prevent the formation of acidic condensation within engine subsystem components such as an exhaust gas recirculation (EGR) cooler and an intake manifold. An air dryer is incorporated so that charge air within such components is maintained in as close to an unsaturated condition as possible.

### BACKGROUND OF THE INVENTION

1. Field of the Invention

The present invention generally relates to systems that modify the composition of air prior to its introduction into an intake manifold of an internal combustion engine having an exhaust gas recirculation (EGR) system and more particularly relates to systems that reduce the moisture content of the engine intake air.

2. Background Art

In a typical internal combustion engine, fuel is mixed with air and ignited in a combustion chamber. Air has a composition of approximately 78 percent nitrogen, 21 percent oxygen and 1 percent other gases. The fuel and oxygen take part in combustion and, at sufficiently high temperatures, normally inert nitrogen reacts with oxygen to form nitric oxide (NO). Upon being released into the atmosphere, nitric oxide readily oxidizes to form toxic nitrogen dioxide (NO₂). The latter is photochemically decomposed by sunlight to form nitric oxide and atomic oxygen, and the latter can initiate a reaction to form ozone (O₃).

Temperature has the greatest influence on the rate of formation of nitric oxide from atmospheric nitrogen. Combustion temperatures are commonly reduced by using an exhaust gas recirculation system, which returns a controlled amount of exhaust gas to engine combustion chambers. The reduction of combustion temperatures generally reduces the production of oxides of nitrogen (NOₓ).

Various forms of exhaust gas recirculation (EGR) systems have existed since at least the early 1970s. An early system simply included a few holes between intake and exhaust manifolds. A more sophisticated system including EGR valves was subsequently developed. These controlled valves meter the amount of exhaust gas based upon a calculation that is typically a function of air/fuel mixture, combustion chamber configuration, engine displacement, exhaust system back pressure, ignition timing and valve overlap.

Unfortunately, advantages resulting from the introduction of exhaust gas recirculation, especially when the exhaust gas is cooled, are often accompanied by a problem of condensation. Due to components in fuel and air, EGR condensation is acidic. The action of sulfuric acid on the cylinder walls of an engine promotes an increase of cylinder liner and piston ring wear, which increases the frequency with which they must be replaced. Failure to replace these components sufficiently often makes an engine more susceptible to a migration of sulfuric acid past its piston rings and into its crankcase, acidifying engine oil therein. This promotes an increase in main bearing wear, which requires more frequent major engine overhauls and oil replacement. In view of the foregoing, many manufacturers consider the condensation of sulfuric acid and the problems caused by its corrosive effects to be a major factor in limiting the extent to which cooled EGR can be used.

Proposed solutions to the acidic condensation problem have included the reduction of the amount of sulfur in diesel fuel, the use of special corrosive-resistant materials, and the frequent replacement of parts most vulnerable to damage from acid contact. Certainly, a solution to the acidic condensation problem that would not require these expensive procedures would represent an incremental advance in EGR technology.

While the prior techniques function with a certain degree of efficiency, none discloses the advantages of the charge-air modification system of the present invention as is hereinafter more fully described.

### SUMMARY OF THE INVENTION

The apparatus of the present invention includes a charge-air modification system for use with an internal combustion engine having an intake manifold, an exhaust manifold, and an exhaust gas recirculation (EGR) system. The charge-air modification system includes a turbocharger having a turbine driven by engine exhaust gas and a compressor driven by the turbine to compress engine intake air. Also included is a charge-air cooler disposed between the compressor and a point at which exhaust gas is introduced into the air compressed by the compressor. An air dryer is also disposed in the path of the air ahead of the exhaust gas introduction point just described. The action of the air dryer minimizes condensation within, and attendant corrosive effects on, engine subsystem components such as the EGR cooler and intake manifold.

### BRIEF DESCRIPTION OF THE DRAWINGS

A more complete appreciation of the invention and many of the attendant advantages thereof may be readily obtained by reference to the following detailed description when considered with the accompanying drawings in which like reference characters indicate corresponding parts in all the views, wherein:

FIG. 1 is a schematic representation of a first embodiment of the present invention shown connected to a typical diesel engine;

FIG. 2 is a schematic representation of a second embodiment of the present invention shown connected to a typical diesel engine;

FIG. 3 is a schematic representation of a third embodiment of the present invention shown connected to a typical diesel engine;

FIG. 4 is a first graphic representation of a dew-point curve shown as a function of a first set of pressure, temperature and humidity ratio values; and

FIG. 5 is a second graphic representation of a dew-point curve shown as a function of a second set of pressure, temperature and humidity ratio values.

### DETAILED DESCRIPTION OF THE PREFERRED EMBODIMENTS

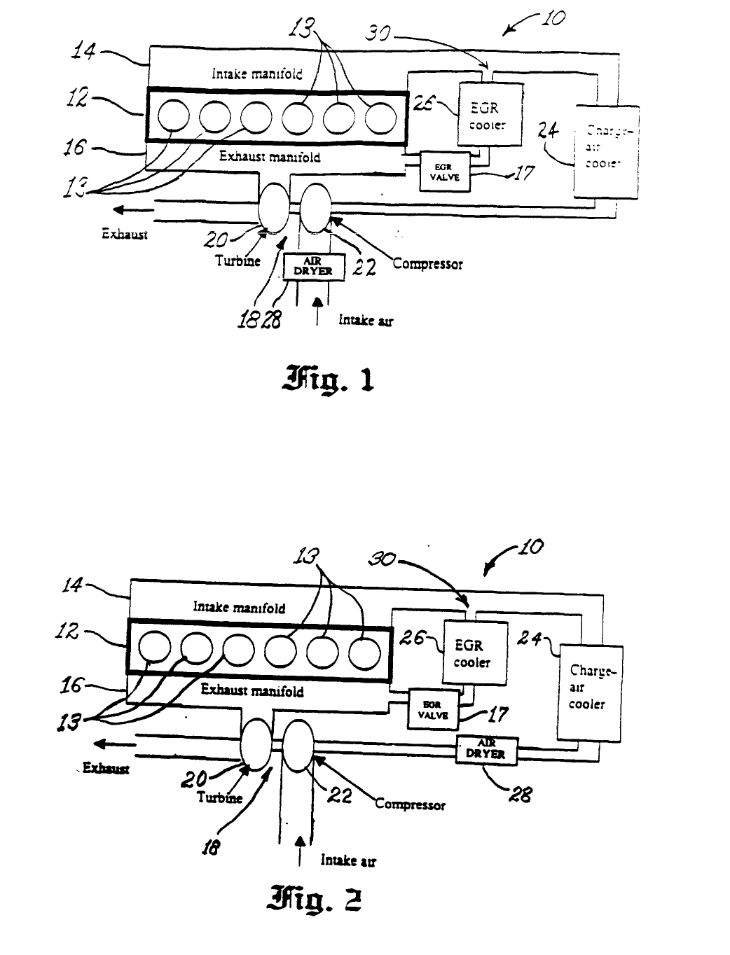

FIGS. 1, 2 and 3 of the drawings are similar diagrams, each representing a charge-air modification system generally indicated by reference numeral 10, of the present invention. The charge-air modification system 10 is shown as it would typically be connected to a diesel engine 12 having combustion chambers 13, an intake manifold 14, an exhaust manifold 16 and an exhaust gas recirculation (EGR) system. The charge-air modification system 10 includes a turbocharger, generally indicated by reference numeral 18, a charge-air cooler 24 and an air dryer 28.

The turbocharger 18, includes a turbine 20 and a compressor 22. The turbine 20 is rotatably driven by engine exhaust gas and is coupled to the compressor 22, which compresses intake air before it reaches the intake manifold 14. FIGS. 1, 2 and 3 display an exhaust gas recirculation (EGR) cooler 26 connected between the exhaust manifold 16 and the intake manifold 14 of the engine 12. The EGR cooler 26 is itself typically cooled by engine radiator coolant (not shown), and the charge-air cooler 24 is typically cooled by an air flow primarily created by an engine fan (also not shown) and ambient air flow. It should, however, be understood by those skilled in the present art that other cooling means are capable of cooling these components.

An EGR control valve 17 is commonly used to control the amount of exhaust gas recirculated to the intake manifold 14; and various additional sensing, regulating and actuating components are often included in an EGR system. For the sake of simplicity, however, only the EGR control valve 17 and the cooler 26 have been shown in the EGR system included in FIGS. 1, 2 and 3.

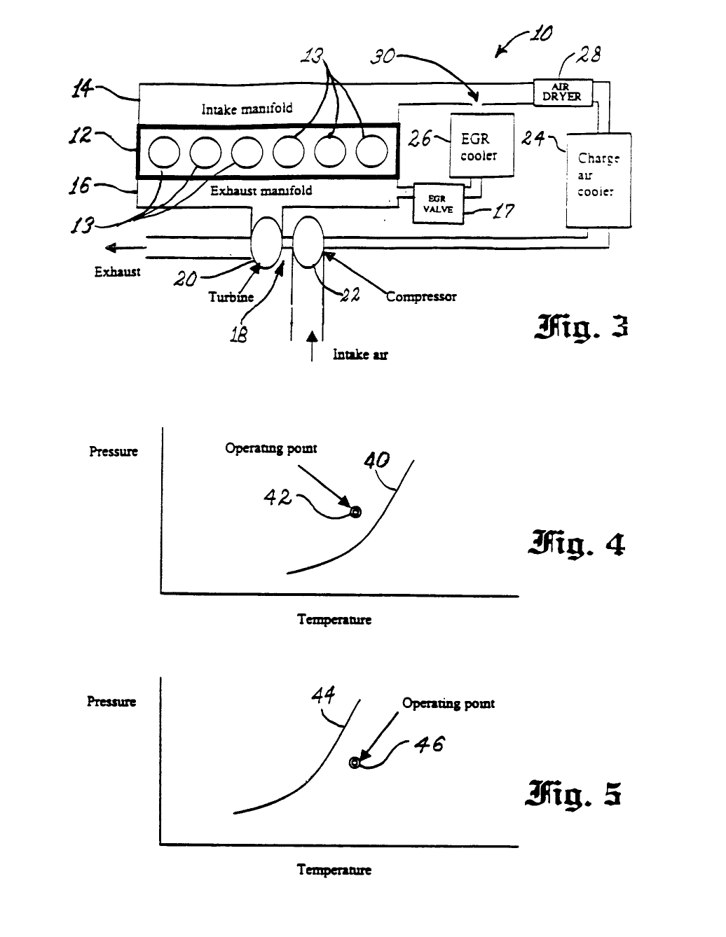

FIG. 1 illustrates a first embodiment of the invention wherein the air dryer 28 is located so that it dries intake air before it passes through the compressor 22. FIG. 2 illustrates a second embodiment of the invention wherein the air dryer 28 is located so that it dries charge air after it leaves the compressor 22 and before it passes through the charge-air cooler 24. FIG. 3 illustrates a third embodiment of the invention wherein the air dryer 28 is located so that it dries charge air after it leaves the charge-air cooler 24 and before it reaches a point, generally indicated by the reference numeral 30, at which exhaust gas is introduced into the charge air.

The air dryer 28 is shown positioned in one of three respective locations in FIGS. 1, 2 and 3. The locations are typically chosen to accommodate various physical and operational requirements and restrictions of the engine and engine compartment; but all locations are located in the “fresh,” intake air, which is relatively cool with respect to the gas beyond the point 30 at which exhaust gas is introduced into the intake air. The air dryer 28 operates in the same manner at each location, but the temperature and pressure of the gas passing therethrough differ. Due, for example, to compression and friction, the pressure and temperature of the charge air passing through the air dryer 28 are highest when the latter is positioned between the compressor 22 and the charge-air cooler 24.

In operation, engine intake air is drawn into, and compressed by, the compressor 22. The compressed air is introduced into the charge-air cooler 24, where it is cooled. The cooled, compressed air is then fed into the intake manifold 14 to support fuel combustion in the combustion chambers 13. While this is taking place, a portion of the exhaust gas is extracted from the exhaust manifold 16, under control of the EGR control valve 17, and is passed through the EGR cooler 26. The exhaust gas, assisted by back pressure in the exhaust manifold 16, is then introduced into the charge air at the point indicated by the reference numeral 30 for passage into the intake manifold 14 and ultimately into the combustion chambers 13.

The presence of the cooled, noncombustable gas in the combustion chambers 13 slows the fuel burning process and lowers the temperature during combustion to a level below that at which normally inert atmospheric nitrogen reacts with oxygen to form nitric oxide (NO). This prevents the formation of toxic nitrogen dioxide (NO₂), which is readily formed by the oxidation of NO after it passes from the exhaust system. Consequently, this precludes photochemical decomposition of the NO₂, which would release atomic oxygen that could initiate a reaction forming ozone (O₃).

The introduction of exhaust gas, however, creates an increased likelihood of there being a resulting formation of acidic condensation. The condensation of sulfuric acid on the cylinder walls of the engine results in increased piston ring and cylinder liner wear. This, in turn, requires that piston rings, cylinder liners and lubricating oil be replaced more frequently. If this is neglected, sulfuric acid passed by the piston rings into the crankcase are capable of promoting an increase in wear of such critical components as main bearings.

The condensation occurs under certain combinations of ambient and engine operating conditions, and this is illustrated by dew-point curves such as those indicated by the reference numerals 40 and 44 in respective FIGS. 4 and 5. Within each engine subsystem component, the ratio of a mass of actual water vapor with respect to an associated mass of air defines a humidity ratio ω, the latter ratio itself being partially dependent on the humidity ratio of ambient air.

For a given humidity ratio ω, each dew-point curve 40 and 44 represents a line of departure between saturated and unsaturated charge air and indicates, for a given pressure, the temperature at which condensation begins. If the engine is operated at a point that is represented as being on the saturated side of a dew-point curve, conditions would be favorable for the formation of condensation within the engine subsystem components. This is illustrated in FIG. 4, which shows a dew-point curve 40 for a humidity ratio of ω₁ and an operating point 42 that is on the saturated side of the dew-point curve 40.

Reducing the humidity ratio of the charge air by introducing an air dryer 28 has the effect of shifting the dew-point curve toward a position that locates the operating point on the unsaturated side of the dew-point curve. FIG. 5 shows a dew-point curve 44 that is similar to that 40 in FIG. 4. Due to the presence of the air dryer 28, however, the humidity ratio ω₂ of the charge air is less than the humidity ratio ω1; and the operating point 46 appears on the unsaturated side of the dew-point curve. Accordingly, condensation in the engine subsystem components is minimized, thus facilitating the resolution of attendant engine component functional, efficiency and longevity problems.

Although no electronic control devices, such as engine control modules (ECM), are necessary and are not shown in the figures, it should be understood by those skilled in the art associated with the present invention that such devices would be functionally compatible therewith.

While embodiments of the invention have been illustrated and described, it is not intended that these embodiments illustrate and describe all possible forms of the invention. Rather, the words used in the specification are words of description rather than limitation, and it is to be understood that various changes may be made without departing from the spirit and scope of the invention.

What is claimed is:

1. A charge-air modification system for use with an internal combustion engine having an intake manifold, an exhaust manifold, and an exhaust gas recirculation system, the charge-air modification system comprising:
a compressor to compress engine intake air;
a charge-air cooler disposed in a path of the engine intake air between the compressor and a point at which exhaust recirculation gas is introduced into the compressed engine intake air; and
an air dryer disposed in the path of the engine intake air ahead of the point at which exhaust recirculation gas is introduced into the compressed engine intake air, the air dryer reducing engine intake air moisture content and resulting condensation, thereby minimizing attendant corrosive effects on engine components.

2. The charge-air modification system as defined by claim 1, further including a turbine driven by engine exhaust gas and drivingly connected to the compressor, the turbine and the compressor cooperating to constitute a turbocharger.

3. The charge-air modification system as defined by claim 2, wherein the air dryer is disposed in the path of the engine intake air ahead of the compressor.

4. The charge-air modification system as defined by claim 2, wherein the air dryer is disposed in the path of the engine intake air between the compressor and the charge-air cooler.

5. The charge-air modification system as defined by claim 2, wherein the air dryer is disposed in the path of the engine intake air between the charge-air cooler and the point at which exhaust gas is introduced into the engine intake air.

6. An internal combustion engine, comprising:
an intake manifold;
an exhaust manifold;
an exhaust gas recirculation system;
a compressor to compress engine intake air;
a charge-air cooler disposed in a path of the engine intake air between the compressor and a point at which exhaust recirculation gas is introduced into the compressed engine intake air; and
an air dryer disposed in the path of the engine intake air ahead of the point at which exhaust recirculation gas is introduced into the compressed engine intake air, the air dryer reducing engine intake air moisture content and resulting condensation, thereby minimizing attendant corrosive effects on engine components.

7. The internal combustion engine as defined by claim 6, further including a turbine driven by engine exhaust gas and drivingly connected to the compressor, the turbine and the compressor cooperating to constitute a turbocharger.

8. The internal combustion engine as defined by claim 7, wherein the air dryer is disposed in the path of the engine intake air ahead of the compressor.

9. The internal combustion engine as defined by claim 7, wherein the air dryer is disposed in the path of the engine intake air between the compressor and the charge-air cooler.

10. The internal combustion engine as defined by claim 7, wherein the air dryer is disposed in the path of the engine intake air between the charge-air cooler and the point at which exhaust gas is introduced into the engine intake air.

11. In a charge-air modification system for use with an internal combustion engine having an intake manifold, an exhaust manifold, and an exhaust gas recirculation system, a method of drying charge air in preparation for combining it with gas flowing from the exhaust gas recirculation system to the intake manifold, the method comprising the steps of:
a. providing a compressor to compress engine intake air;
b. providing a charge-air cooler disposed in a path of the engine intake air between the compressor and a point at which exhaust recirculation gas is introduced into the compressed engine intake air; and
c. providing an air dryer disposed in the path of the engine intake air ahead of the point at which exhaust recirculation gas is introduced into the compressed engine intake air, the air dryer reducing engine intake air moisture content and resulting condensation, thereby minimizing attendant corrosive effects on engine components.

12. The method as defined by claim 11, wherein step c further includes locating the charge-air cooler in the path of the engine air ahead of the compressor.

13. The method as defined by claim 11, wherein step c further includes locating the charge-air cooler in the path of the engine air between the compressor and the charge-air cooler.

14. The method as defined by claim 11, wherein step c further includes locating the charge-air cooler in the path of the engine air between the charge-air cooler and the point at which exhaust gas is introduced into the engine intake air.

15. In an internal combustion engine having an intake manifold, an exhaust manifold, and an exhaust gas recirculation system, a method of drying charge air in preparation for combining it with gas flowing from the exhaust gas recirculation system to the intake manifold, the method comprising the steps of:
a. providing a compressor to compress engine intake air;
b. providing a charge-air cooler disposed in a path of the engine intake air between the compressor and a point at which exhaust recirculation gas is introduced into the compressed engine intake air; and
c. providing an air dryer disposed in the path of the engine intake air ahead of the point at which exhaust recirculation gas is introduced into the compressed engine intake air, the air dryer reducing engine intake air moisture content and resulting condensation, thereby minimizing attendant corrosive effects on engine components.

16. The method as defined by claim 15, wherein step c further includes locating the charge-air cooler in the path of the engine air ahead of the compressor.

17. The method as defined by claim 15, wherein step c further includes locating the charge-air cooler in the path of the engine air between the compressor and the charge-air cooler.

18. The method as defined by claim 15, wherein step c further includes locating the charge-air cooler in the path of the engine air between the charge-air cooler and the point at which exhaust gas is introduced into the engine intake air.
